(19) United States
(12) Patent Application Publication
(10) Pub. No.: US 2008/0259018 A1
(43) Pub. Date: Oct. 23, 2008

(54) LIQUID CRYSTAL DEVICE, METHOD OF DRIVING THE SAME AND ELECTRONIC APPARATUS

(75) Inventor: Toshiyuki Kasai, Okaya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/023,464

(22) Filed: Jan. 31, 2008

(30) Foreign Application Priority Data
Mar. 12, 2007 (JP) 2007-061351

(51) Int. Cl. G09G 3/36

(52) U.S. Cl. 345/96

(57) ABSTRACT

A liquid crystal device has a display mode in which an image is displayed and a non-display mode in which no image is displayed. A scanning line driving device selects a plurality of scanning lines in a predetermined order every unit period. A data line driving device supplies pixel circuits corresponding to a selected one of the scanning lines through the data lines with writing voltages. The data line driving device, in the non-display mode, supplies each data line with the predetermined voltage, as the writing voltage, of which polarity is inverted in a period of integral multiple of the unit period using the reference electric potential as a reference. The scanning line driving device, in the non-display mode, selects each of the scanning lines in a unit period that is longer than the unit period of the display mode.

### BACKGROUND

1. Technical Field

The present invention relates to a liquid crystal device that uses a liquid crystal with bend alignment and splay alignment as an alignment state, a method of driving the liquid crystal device and an electronic apparatus.

2. Related Art

A liquid crystal device that performs display using a liquid crystal varying its transmittance ratio is widely used as a display device of an electronic apparatus, such as an information processing device, a television, or a cellular phone. In the liquid crystal device, pixel electrodes are formed at positions corresponding to intersections of scanning lines that extend in a row direction and data lines that extend in a column direction. In addition, a pixel switch, such as a thin-film transistor (hereinafter, referred to as TFT, where appropriate), that turns on/off on the basis of a scanning signal supplied to a corresponding one of the scanning lines is provided at each of the intersections and interposed between each of the pixel electrodes and a corresponding one of the data lines. Furthermore, an opposite electrode is provided so as to be opposed to the pixel electrodes via the liquid crystal. An alignment state of the liquid crystal varies on the basis of a voltage applied between the pixel electrodes and the opposite electrode. In this manner, the amount of light transmitted in each of pixels is varied, thus making it possible to perform a predetermined display.

An Optical Compensated Bend (OCB) mode liquid crystal, which has been progressively developed in recent years as a new display mode, has two types of alignment states, that is, a splay alignment and a bend alignment. The bend alignment is suitable for image display and is able to respond at a speed higher than an existing Twisted Nematic (TN) liquid crystal. When an initial state, that is, a state where an applied voltage is 0 V, has been continued for a long time, the OCB liquid crystal is placed in the splay alignment that is not suitable for image display. Therefore, when an image is displayed, it is necessary to perform an initial transition operation when power is on, or the like, to transfer liquid crystal molecules to the bend alignment. The transition from the splay alignment to the bend alignment in the initial transition operation is performed by applying a high voltage for a certain period of time.

Even when the transition from the splay alignment to the bend alignment is once performed through the initial transition operation, if a voltage of a predetermined level or above is not applied for some time, the OCB liquid crystal cannot maintain the bend alignment and returns from the bend alignment to the splay alignment. This phenomenon is called reverse transition. JP-A-2002-328654 describes that, in order to suppress the occurrence of reverse transition, image data and non-image data that are in a state of large difference in electric potential are alternately written into liquid crystal pixels. In a normally white OCB liquid crystal, the state of large difference in electric potential corresponds to black display, so that inserting non-image data to maintain the bend alignment is also called black insertion.

As described above, a liquid crystal device is widely used as a display device of an electronic apparatus, such as an information processing device or a cellular phone. In the above electronic apparatus, it is often performed to reduce power consumption and/or to prevent degradation of a display device by not always holding the display device in a display state but by having the display device in a non-display state depending on a situation.

In the non-display state, it is not necessary to write image data, so that it is conceivable that the supply of voltage to liquid crystal pixels is stopped. However, when the supply of voltage is stopped, the reverse transition will occur. Thus, when it is returned to a display state, it is necessary to perform the initial transition operation again. In general, the initial transition operation needs several seconds, so that it takes some time to return to the display state. Then, in order to quickly return to the display state, it is necessary to perform black insertion in the non-display state to maintain the bend alignment. For this reason, even in the non-display state, power is consumed for black insertion operation.

### SUMMARY

An advantage of some aspects of the invention is to prevent a reverse transition while reducing power consumption, when display is not performed in a liquid crystal device.

An aspect of the invention provides a liquid crystal device. The liquid crystal device includes a plurality of scanning lines, a plurality of data lines, a plurality of pixel circuits, a scanning line driving device, and a data line driving device. The plurality of pixel circuits are provided at positions corresponding to intersections of the scanning lines and the data lines. Each of the plurality of pixel circuits includes a liquid crystal element that has a first electrode, a second electrode supplied with a reference electric potential, and a liquid crystal held between the first electrode and the second electrode. An alignment state for the liquid crystal includes a first alignment, which is an initial state, and a second alignment, which is used for display, wherein a predetermined voltage needs to be applied to maintain the second alignment. The liquid crystal device has a display mode in which an image is displayed and a non-display mode in which no image is displayed. The scanning line driving device selects the plurality of scanning lines in a predetermined order every unit period. The data line driving device supplies the pixel circuits corresponding to a selected one of the scanning lines through the data lines with writing voltages. The data line driving device, in the non-display mode, supplies each data line with the predetermined voltage, as the writing voltage, of which polarity is inverted in a period of integral multiple of the unit period using the reference electric potential as a reference. The scanning line driving device, in the non-display mode, selects each of the scanning lines in a unit period that is longer than the unit period of the display mode.

According to the above aspect of the invention, even in the non-display mode in which no image is displayed, a predetermined voltage is applied to maintain the alignment state of the liquid crystal in the second alignment. The liquid crystal is driven through alternating current driving method that applies an alternating voltage. In the alternating current driving method in the non-display mode, a predetermined voltage, as a writing voltage, of which polarity is inverted in a period of integral multiple of a unit period using a reference electric potential as a reference is supplied to each data line. Because the length of a unit period is set longer in the non-display mode than in the display mode, it is possible to reduce the number of times electric charge and discharge are performed per unit time on the parasitic capacitance formed in each data line. As a result, it is possible to reduce power consumption associated with electric charge and discharge.

In the above described liquid crystal device, the scanning line driving device, in the display mode, may select each of the plurality of scanning lines twice in one frame period that is formed of a plurality of the unit periods, wherein the data line driving device, in the display mode, may mix, in one frame period, a period in which a gray-scale voltage is supplied to each of the data lines as the writing voltage and a period in which the predetermined voltage is supplied to each of the data lines as the writing voltage. In this case, a driving method in the display mode includes the following embodiments. In a first embodiment, one frame period in the display mode may be divided into a first period and a second period, and, in each of the first period and the second period, the scanning lines are sequentially selected. Then, in the first period, a gray-scale voltage, of which polarity is inverted every unit period using a reference electric potential as a reference, corresponding to a gray-scale level to be displayed, is supplied to each liquid crystal element that corresponds to a selected one of the scanning lines, and, in the second period, a predetermined voltage, of which polarity is inverted every unit period using a reference electric potential as a reference is supplied to each liquid crystal element corresponding to a selected one of the scanning lines (see FIG. 3). In addition, in a second embodiment, a scanning line may be selected in a certain unit period and a gray-scale voltage may be supplied through each data line, and, in the next unit period, a scanning line different from the above scanning line may be selected and a predetermined voltage having the same polarity as that of the above gray-scale voltage may be supplied (see FIG. 4). In the second embodiment, because it is possible to reduce a voltage duration, of electric charge and discharge performed on the parasitic capacitance formed in each data line, it is possible to reduce power consumption in the display mode.

In addition, a specific embodiment of the liquid crystal may be an OCB (Optical Compensated Bend) mode liquid crystal, wherein the first alignment is a splay alignment and the second alignment is a bend alignment. The OCB liquid crystal has a short response time of transmittance ratio to a voltage applied thereto, so that it is possible to display a high-quality moving image. Moreover, the above described liquid crystal device may further include a backlight that turns on a light in the display mode and that turns off a light in the non-display mode. In this case, the liquid crystal device is of a transmissive type; however, because the backlight may be turned off in the non-display mode, it is possible to reduce power consumption in the non-display mode.

The above described liquid crystal device may further include a control device that generates a first clock signal and a second clock signal, wherein the scanning line driving device operates in synchronization with the first clock signal, wherein the data line driving device operates in synchronization with the second clock signal, wherein the control device, in the non-display mode, sets the first clock signal to a frequency lower than that in the display mode and, in the non-display mode, sets the second clock signal to a frequency lower than that in the display mode. In this case, by using the frequency of the clock signal as a control target, it is possible to adjust the length of unit period.

Next, another aspect of the invention provides an electronic apparatus that is provided with the above described liquid crystal device. The above liquid crystal device includes, for example, a personal computer, a cellular phone, and a personal digital assistants.

Yet another aspect of the invention provides a method of driving a liquid crystal device. The liquid crystal device includes a plurality of scanning lines, a plurality of data lines, and a plurality of pixel circuits. The plurality of pixel circuits are provided at positions corresponding to intersections of the scanning lines and the data lines. Each of the plurality of pixel circuits includes a liquid crystal element that has a first electrode, a second electrode supplied with a reference electric potential, and a liquid crystal held between the first electrode and the second electrode. An alignment state for the liquid crystal includes a first alignment, which is an initial state, and a second alignment, which is used for display, wherein a predetermined voltage needs to be applied to maintain the second alignment. The method of driving the liquid crystal device includes driving the liquid crystal device in a display mode in which an image is displayed and a non-display mode in which no image is displayed, in the display mode, selecting the plurality of scanning lines in a predetermined order every unit period and supplying the pixel circuits corresponding to a selected one of the scanning lines through the data lines with writing voltages, in the non-display mode, selecting the plurality of scanning lines in a predetermined order every unit period and supplying the pixel circuits corresponding to a selected one of the scanning lines through the data lines with the predetermined voltage, of which polarity is inverted in a period of integral multiple of the unit period using the reference electric potential as a reference, and setting the length of the unit period longer in the non-display mode than in the display mode. According to the above aspect of the invention, because the length of a unit period is set longer in the non-display mode, than in the display mode, it is possible to reduce the number of times electric charge and discharge are performed per unit time on the parasitic capacitance formed in each data line. As a result, it is possible to reduce power consumption associated with electric charge and discharge.

### BRIEF DESCRIPTION OF THE DRAWINGS

The invention will be described with reference to the accompanying drawings, wherein like numbers reference like elements.

FIG. 1 is a block diagram of a liquid crystal device according to an embodiment of the invention.

FIG. 2 is a block diagram that shows a detailed configuration of an image display area of the liquid crystal device.

FIG. 3 is a waveform chart that illustrates a driving timing of the liquid crystal device.

FIG. 4 is a waveform chart that illustrates a driving timing of the liquid crystal device.

FIG. 5 is a perspective view of a personal computer, which is one example of an electronic apparatus.

FIG. 6 is a perspective view of a cellular phone, which is one example of an electronic apparatus.

FIG. 7 is a perspective view of a personal digital assistants, which is one example of an electronic apparatus.

### DESCRIPTION OF EXEMPLARY EMBODIMENTS

1. Embodiment

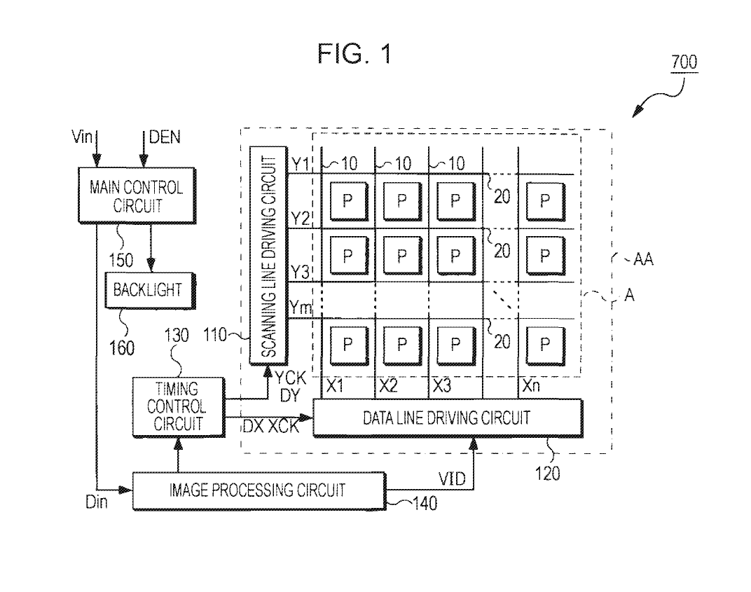

FIG. 1 is a block diagram of a liquid crystal device according to an embodiment. The liquid crystal device 700 uses a liquid crystal as an electro-optical material. The liquid crystal device 700 is provided with a liquid crystal panel AA as a main component. The liquid crystal panel AA is configured so that an element substrate, on which TFTs are formed as switching elements, and an opposite substrate are adhered with a constant gap formed therebetween in such a manner that their electrode forming surfaces are opposed to each other, and the liquid crystal is held in the gap. The liquid crystal of this example is an OCB liquid crystal.

In addition, the liquid crystal device 700 includes a timing control circuit 130, an image processing circuit 140, a main control circuit 150 and a backlight 160. On the element substrate of the liquid crystal panel AA, an image display area A, a scanning line driving circuit 110 and a data line driving circuit 12 0 are formed. The main control circuit 150 converts an input image signal Vin that is supplied from an external device in analog format into a digital signal, and supplies the digital signal to the image processing circuit 140 as input image data Din. In addition, the main control circuit 150 controls lighting of the backlight 160.

The input image data Din supplied from the main control circuit 150 to the image processing circuit 140 are, for example, 24-bit parallel data. The timing control circuit 130, in synchronization with a control signal, such as a horizontal scanning signal or a vertical scanning signal, supplied from the image processing circuit 140, generates a Y clock signal YCK, an X clock signal XCK, a Y transfer start pulse DY, and an X transfer start pulse DX and supplies them to the scanning line driving circuit 110 and the data line driving circuit 120. In addition, the timing control circuit 130 generates and outputs various timing signals that control the image processing circuit 140. Here, the Y clock signal YCK specifies a period during which a scanning line 20 is selected, and the X clock signal XCK specifies a period during which a data line 10 is selected. These clock signals are generated on the basis of driving frequency, which is a reference of operation of the timing control circuit 130. In addition, the Y transfer start pulse DY is a pulse that specifies a start of selection of the scanning line 20, and the X transfer start pulse DX is a pulse that specifies a start of selection of the data line 10.

As will be described later, in the present embodiment, driving frequency in a display mode and driving frequency in a non-display mode may be switched to each other. The driving frequency of the non-display mode is a frequency that is used when image display is not performed by the liquid crystal device 700, and is smaller than the frequency of the display mode. An identification signal DEN that identifies the display mode or the non-display mode is input into the main control circuit 150 from the outside of the liquid crystal device 700. The main control circuit 150 determines a mode on the basis of this signal and then instructs the image processing circuit 140 and the timing control circuit 130 to switch the driving frequency. Note that it may be configured so that, not based on the identification signal DEN input from the outside but based on the input image signal Vin, or the like, the main control circuit 150 itself identifies a mode. The image processing circuit 140 performs gamma correction, or the like, in view of light transmission characteristic of the liquid crystal panel AA, on the input image data Din supplied from the main control circuit 150 and, after that, performs D/A conversion on the image data of each of RGB colors to generate an image signal VID, and then supplies the image signal VID to the liquid crystal panel AA.

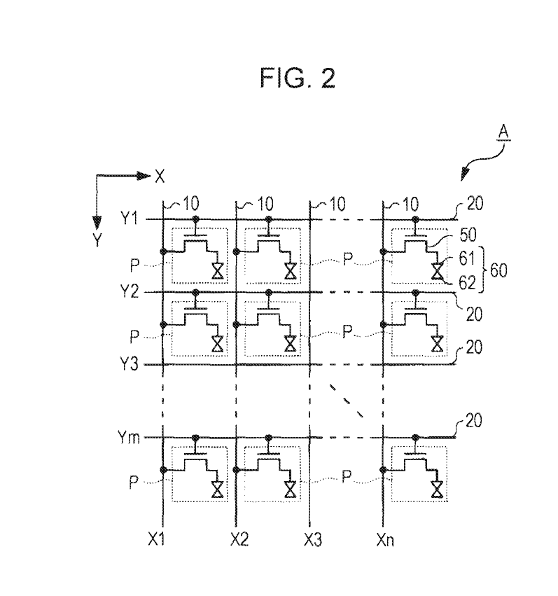

FIG. 2 is a view that shows a detailed configuration of the image display area A. In the image display area A, m (m is natural number equal to or more than one) scanning lines 20 are formed so as to be arranged parallel to an X direction, while n (n is natural number equal to or more than one) data lines 10 are formed so as to be arranged parallel to a Y direction. Then, m×n pixel circuits P are arranged at positions corresponding to intersections of the data lines 10 and the scanning lines 20. As shown in the drawing, each of the pixel circuits P includes a liquid crystal element 60 and a TFT 50. The liquid crystal element 60 is formed so that an OCB liquid crystal is held between a pixel electrode 61 and an opposite electrode 62. A reference electric potential Vcom is supplied to the opposite electrode 62. The gate electrode of the TFT 50 is electrically connected to the corresponding scanning line 20. One of the drain electrode and the source electrode of the TFT 50 is electrically connected to the corresponding data line 10, and the other is electrically connected to the pixel electrode 61.

The data line driving circuit 120 shown in FIG. 1 outputs data signals X1 to Xn to the n data lines 10. Generally, an alternating current driving method is performed in a liquid crystal device. When the polarity of a signal is defined so that an electric potential higher than the reference electric potential Vcom of the opposite electrode 62 is positive polarity and an electric potential lower than the reference electric potential Vcom is negative polarity, in the present embodiment, a dot inversion driving method that combines a line inversion driving method, by which a voltage applied to a liquid crystal is inverted in units of the scanning line 20 and the data line 10, with a frame inversion driving method by which the voltage applied to the liquid crystal is inverted in units of frame is performed. Note that any one of the line inversion driving method and the frame inversion driving method may be used or another driving method may be used.

The scanning lines 20 are sequentially applied with scanning signals Y1, Y2, . . . , Ym in pulse form from the scanning line driving circuit 110. For this reason, as a scanning line 20 is supplied with a scanning signal, the TFT 50 of each pixel circuit P in that corresponding row enters an on state and then a data signal supplied through the corresponding data line 10 is written to the liquid crystal element 60. Because order and alignment of liquid crystal molecules vary on the basis of a voltage level applied to each pixel, it is possible to perform a grayshade using optical modulation.

For example, the amount of light that passes the liquid crystal is reduced as an applied voltage increases in a normally white mode, while, on the other hand, the amount of light that passes the liquid crystal is increased as an applied voltage increases in a normally black mode. Thus, light that has a contrast corresponding to an image signal is emitted from each of the pixels over the entire liquid crystal device 700. The liquid crystal device 700 of this embodiment is normally white. Therefore, in a state where an applied voltage is high, black is displayed. Note that, in order to prevent leakage of an image signal being held, a holding capacitor may be added in parallel with a liquid crystal capacitor formed between each of the pixel electrodes 61 and the corresponding opposite electrode 62.

Here, the display mode and the non-display mode will be described. In general, in an electronic apparatus that uses the liquid crystal device 700 as a display device, the display device is not always held in a display state but often made into a non-display state depending on the situation to reduce power consumption and to prevent degradation of the display device. Here, a driving mode in the display state is termed as a display mode, and a driving mode in a non-display state is termed as a non-display mode.

A condition to shift from the display mode to the non-display mode may be set to when an operation is not received for a predetermined period of time or the same screen is continuously displayed for a predetermined period of time, when the display face of the liquid crystal device 700 is covered with a cover or is closed, when an instruction to perform a non-display mode is received from a user, or the like. For this reason, the electronic apparatus provided with the liquid crystal device 700 has a detection function, such as a timer or a sensor. On the other hand, a condition to shift from the non-display mode to the display mode may be set to when an operation is received or a screen display is changed, when a cover is removed or opened, when an instruction to perform a display state is received from a user, or the like. Note that, in the non-display mode, it is desirable to turn off the backlight 160 in terms of reducing power consumption.

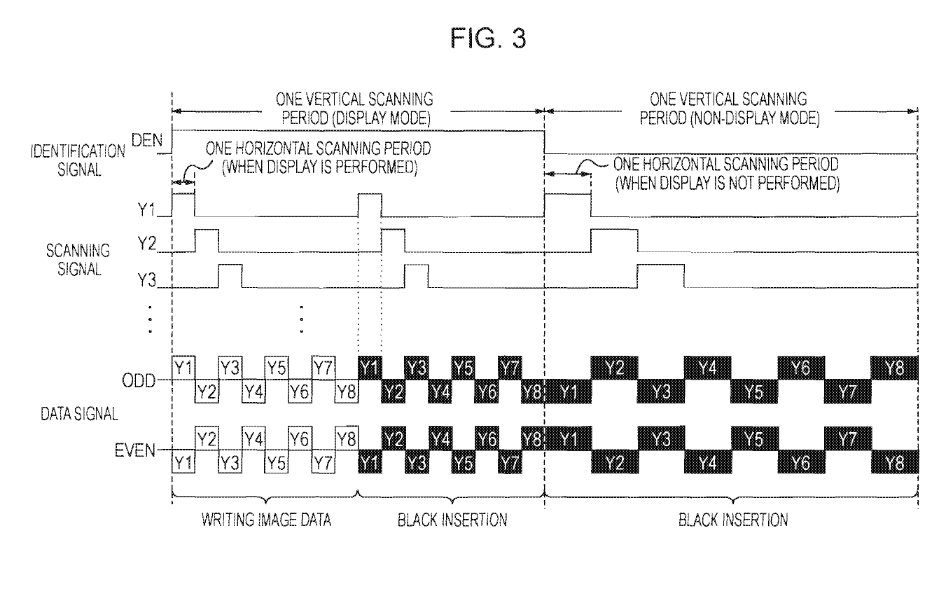

Next, a driving timing of the liquid crystal device 700 in the display mode and in the non-display mode will be described. For easier description, the driving timing will be described with reference to FIG. 3 in which a black insertion pattern is simple. FIG. 3 is a view that shows a relationship among the identification signal DEN, the scanning signals Y1, Y2, Y3, . . . , and the data signals. In this embodiment, eight scanning lines Y1 to Y8 are described, and polarity inversion is performed on the data signals every line. In addition, the data signals are driven so that odd-numbered (ODD) pixels and even-numbered (EVEN) pixels have alternate polarities and the polarities are inverted every frame. That is, the dot inversion driving is performed. The identification signal DEN indicates a display mode when it is at a high level and indicates a non-display mode when it is at a low level.

As shown in the drawing, in the display mode, in the first half of one frame, image data are sequentially written every line in synchronization with the scanning signals (Y1 to Y8). After that, in the second half of the one frame, so-called black insertion is performed. That is, writing of black data as non-image data is sequentially performed in synchronization with each of the scanning signals (Y1 to Y8), thus preventing reverse transition. In the display mode, the thus writing of image data and writing of non-image data for preventing reverse transition are alternately performed.

As the identification signal DEN attains a low level, the mode is shifted from the display mode to the non-display mode. As shown in the drawing, in the non-display mode, writing of image data is not performed, but writing of black data for preventing reverse transition is performed only. In the present embodiment, at this time, the driving frequency is lowered to extend the duration of each scanning signal. Specifically, in the non-display mode, the frequency of the Y clock signal YCK (first clock signal) is lowered in comparison with that in the display mode. Then, the data signals that indicate black data are synchronized with the above scanning signals. Specifically, the X clock signal (second clock signal) that is synchronized with the Y clock signal YCK is generated. That is, in the non-display mode, the frequency of the X clock signal YCK is lowered in comparison with that in the display mode.

In general, each of the data lines 10 has a capacitive load. As described above, in the present embodiment, because a driving method for inversion in units of line is employed, when focusing on a certain data line 10, the polarity of a data signal supplied to that data line 10 inverts every one horizontal scanning period (unit period) using the reference electric potential Vcom as a reference. In the present embodiment, the length of one horizontal scanning period is set longer in the non-display mode than in the display mode. For this reason, the number of times electric charge and discharge are performed per unit time on the parasitic capacitance of each data line 10 is smaller in the non-display mode than in the display mode. Thus, it is possible to reduce power consumption associated with electric charge and discharge performed on the parasitic capacitance of each data line 10. Note that the driving frequency in the non-display mode is set to ensure a frequency that is sufficient to prevent reverse transition in relation with a voltage of black data written in black insertion. In this manner, the reverse transition is prevented in the non-display mode, and it is possible to achieve a reduction in power consumption.

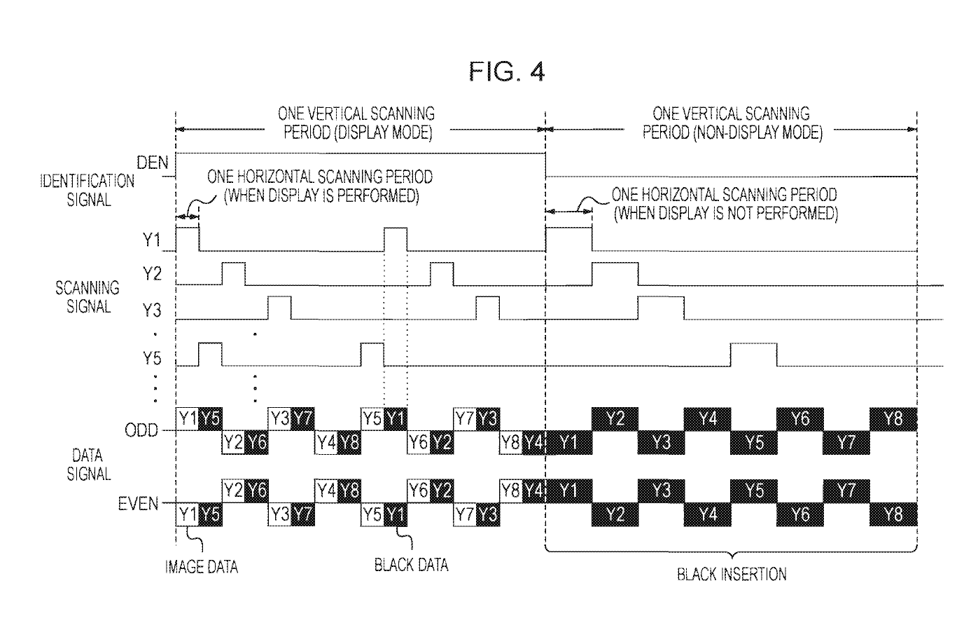

Next, FIG. 4 is a view that shows another example of a driving method. In this example, this example differs from the above described example shown in FIG. 3 in a pattern of black insertion in the display mode. That is, in the display mode, writing of image data for different lines (for example, Y1 and Y5, Y2 and Y6, . . . ) and writing of non-image data for preventing reverse transition are continuously performed. When a driving method for inversion in units of line is performed, the polarity of a writing voltage applied to the liquid crystal element 60 corresponding to a certain scanning line and the polarity of a writing voltage applied to the liquid crystal element 60 corresponding to the next scanning line are inverted. Therefore, in the example shown in FIG. 3, a voltage applied to each data line is inverted every scanning period in a period when image data allocated to the first half of one vertical scanning period (one frame period) is written, and a voltage applied to each data line is inverted every horizontal scanning period in a period when non-image data allocated to the second half of the one vertical scanning period is written. In contrast to this, in the example shown in FIG. 4, in the display mode, a certain scanning line is selected, and image data are then written to the liquid crystal element 60. After that, a different scanning line is selected to write black data having the same polarity to the liquid crystal element 60. In this manner, because it is possible to reduce a voltage duration of electric charge and discharge performed on the parasitic capacitance of each data line 20, it is possible to reduce power consumption in the display mode.

As the identification signal DEN attains a low level, the mode is shifted from the display mode to the non-display mode. In the non-display mode, the same driving control as in the example shown in FIG. 3 may be employed. That is, in the non-display mode, writing of image data is not performed, but writing of black data for preventing reverse transition is performed only. At this time, the driving frequency is lowered to extend the duration of each scanning signal. Then, the data signals that indicate black data are synchronized with the above scanning signals. In this manner, in this example as well, the reverse transition is prevented in the non-display mode, and it is possible to achieve a reduction in power consumption.

Note that, in the above described embodiment, the driving method in which the polarity of a writing voltage to the liquid crystal element 60 is inverted in units of one scanning line using the reference electric potential Vcom as a reference is described as one example; however, the aspects of the invention are not limited to it. The polarity of a writing voltage may be inverted every predetermined number of scanning lines. In this case, it is only necessary that the data line driving circuit 120, in the display mode, supplies each data line 10 with image data (a gray-scale voltage corresponding to a gray-scale to be displayed), as a writing voltage, of which polarity is inverted in a period of integral multiple of a horizontal scanning period using a reference electric potential as a reference, and, in the non-display mode, supplies each data line 10 with black data (predetermined voltage), as a writing voltage, of which polarity is inverted in a period of integral multiple of a horizontal scanning period using a reference electric potential as a reference.

2. Electronic Apparatuses

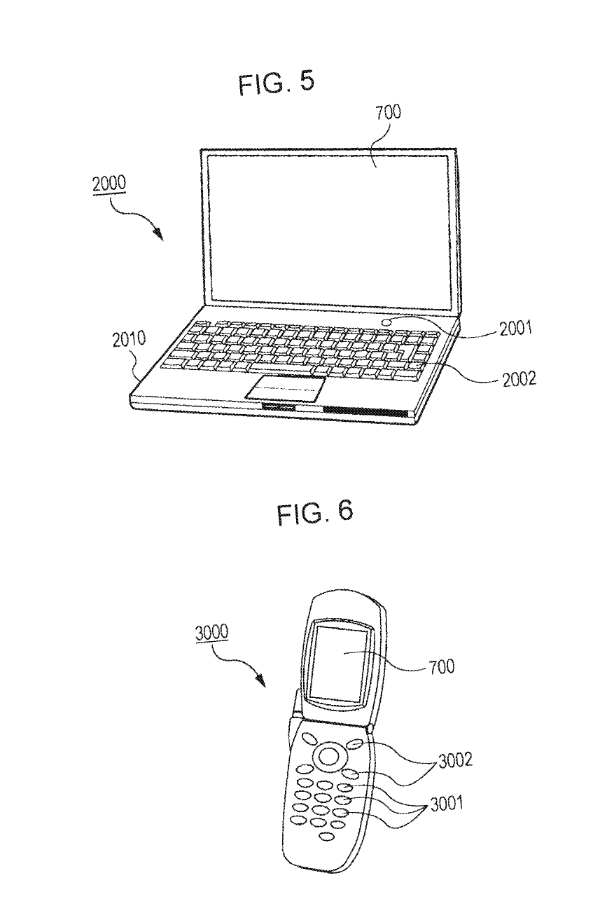

Next, electronic apparatuses that use the liquid crystal device 700 according to the aspects of the invention will be described. FIG. 5 is a perspective view that shows a configuration of a mobile personal computer that uses the liquid crystal device 700 as a display device according to any one of the embodiments described above. The personal computer 2000 includes the liquid crystal device 700, which serves as a display device, and a main body portion 2010. The main body portion 2010 is provided with a power switch 2001 and a keyboard 2002. The personal computer 2000 is shifted to a non-display mode, when not receiving any operation for a predetermined period of time, when the cover portion that accommodates the liquid crystal device 700 is closed, or the like.

FIG. 6 is a view that shows a configuration of a cellular phone that uses the liquid crystal device 700 according to the embodiment. The cellular phone 3000 includes a plurality of operation buttons 3001, a plurality of scroll buttons 3002, and the liquid crystal device 700, which serves as a display device. By manipulating the scroll buttons 3002, a screen displayed on the liquid crystal device 700 will be scrolled. The cellular phone 3000 is shifted to a non-display mode, when not receiving any operation for a predetermined period of time, when the folding body is closed, or the like.

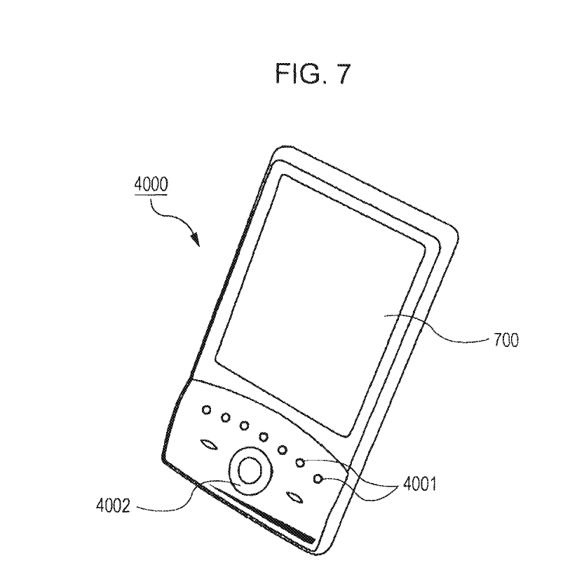

FIG. 7 is a view that shows a configuration of a personal digital assistants (PDA) that uses the liquid crystal device 700 according to the embodiment. The personal digital assistants 4000 includes a plurality of operation buttons 4001, a power switch 4002, and the liquid crystal device 700, which serves as a display device. As the power switch 4002 is manipulated, various pieces of information, such as an address book and a schedule book, are displayed on the liquid crystal device 700. The personal digital assistants 4000 is shifted to a non-display mode, when not receiving any operation for a predetermined period of time, or the like.

Note that the electronic apparatuses that employ the liquid crystal device according to the aspects of the invention include, in addition to the apparatuses shown in FIG. 5 to FIG. 7, a projector, a television, a video camera, a car navigation system, a pager, an electronic personal organizer, an electronic paper, an electronic calculator, a word processor, a workstation, a video telephone, a POS terminal, a printer, a scanner, a photocopier, a video player, and a device provided with a touch panel.

The entire disclosure of Japanese Patent Application No. 2007-061351, filed Mar. 12, 2007 is expressly incorporated by reference herein.

What is claimed is:

1. A liquid crystal device comprising:
a plurality of scanning lines;
a plurality of data lines;
a plurality of pixel circuits that are provided at positions corresponding to intersections of the scanning lines and the data lines, wherein each of the plurality of pixel circuits includes a liquid crystal element that has a first electrode, a second electrode supplied with a reference electric potential, and a liquid crystal held between the first electrode and the second electrode, wherein an alignment state for the liquid crystal includes a first alignment, which is an initial state, and a second alignment, which is used for display, wherein a predetermined voltage needs to be applied to maintain the second alignment, wherein the liquid crystal device has a display mode in which an image is displayed and a non-display mode in which no image is displayed;
a scanning line driving device that selects the plurality of scanning lines in a predetermined order every unit period; and
a data line driving device that supplies the pixel circuits corresponding to a selected one of the scanning lines through the data lines with writing voltages, wherein
the data line driving device, in the non-display mode, supplies each data line with the predetermined voltage, as the writing voltage, of which polarity is inverted in a period of integral multiple of the unit period using the reference electric potential as a reference, and wherein
the scanning line driving device, in the non-display mode, selects each of the scanning lines in a unit period, that is longer than the unit period of the display mode.

2. The liquid crystal device according to claim 1, wherein
the scanning line driving device, in the display mode, selects each of the plurality of scanning lines twice in one frame period that is formed of a plurality of the unit periods, wherein
the data line driving device, in the display mode, mixes, in one frame period, a period in which a gray-scale voltage is supplied to each of the data lines as the writing voltage and a period in which the predetermined voltage is supplied to each of the data lines as the writing voltage.

3. The liquid crystal device according to claim 1, wherein the liquid crystal is an optical compensated bend (OCB) mode liquid crystal, wherein the first alignment is a splay alignment and the second alignment is a bend alignment.

4. The liquid crystal device according to claim 1, further comprising;
a backlight that turns on a light in the display mode and that turns off a light in the non-display mode.

5. The liquid crystal device according to claim 1, further comprising:
a control device that generates a first clock signal and a second clock signal, wherein
the scanning line driving device operates in synchronization with the first clock signal, wherein
the data line driving device operates in synchronization with the second clock signal, wherein
the control device, in the non-display mode, sets the first clock signal to a frequency lower than that, in the display mode and, in the non-display mode, sets the second clock signal to a frequency lower than that in the display mode.

6. An electronic apparatus comprising the liquid crystal device according to claim 1.

7. A method of driving a liquid crystal device that includes a plurality of scanning lines, a plurality of data lines, and a plurality of pixel circuits, wherein the plurality of pixel circuits are provided at positions corresponding to intersections of the scanning lines and the data lines, wherein each of the plurality of pixel circuits includes a liquid crystal element that has a first electrode, a second electrode supplied with a reference electric potential, and a liquid crystal held between the first electrode and the second electrode, wherein an alignment state for the liquid crystal includes a first alignment, which is an initial state, and a second alignment, which is used for display, wherein a predetermined voltage needs to be applied to maintain the second alignment, the method comprising:
driving the liquid crystal device in a display mode in which an image is displayed and a non-display mode in which no image is displayed;
in the display mode, selecting the plurality of scanning lines in a predetermined order every unit period and supplying the pixel circuits corresponding to a selected one of the scanning lines through the data lines with writing voltages;
in the non-display mode, selecting the plurality of scanning lines in a predetermined order every unit period and supplying the pixel circuits corresponding to a selected one of the scanning lines through the data lines with the predetermined voltage, of which polarity is inverted in a period of integral multiple of the unit period using the reference electric potential as a reference; and
setting the length of the unit period longer in the non-display mode than in the display mode.
